(19) United States
(12) Patent Application Publication
(10) Pub. No.: US 2022/0136642 A1
(43) Pub. Date: May 5, 2022

(54) DISPLAY CABLE MANAGEMENT STRUCTURE AND DISPLAY

(71) Applicants: K-TRONICS (SU ZHOU) TECHNOLOGY CO., LTD., Suzhou (CN); BOE Technology Group Co., Ltd., Beijing (CN)

(72) Inventor: Di Wang, Beijing (CN)

(73) Assignees: Chengdu BOE Optoelectronics Technology Co., Ltd.; BOE Technology Group Co., Ltd.

(21) Appl. No.: 17/326,410

(22) Filed: May 21, 2021

(30) Foreign Application Priority Data
Oct. 30, 2020 (CN) 202022477926.3

(51) Int. Cl. F16M 11/20; H02G 15/007

(52) U.S. Cl. CPC F16M 11/2021; H02G 15/007

(57) ABSTRACT

This application provides a display cable management structure and a display. The display cable management structure includes a bracket with a groove, the groove forms an arrangement space for accommodating a cable, and the groove is provided with at least one stop block for preventing the cable from falling out of the arrangement space; and the at least one stop block is movably installed in the groove in an extending direction of the groove, and the at least one stop block separates an opening of the groove into two cable passing openings for the cable to pass in and out of the arrangement space.

### CROSS REFERENCE TO RELATED APPLICATIONS

This application is based on and claims priority under 35 U.S.C. 119 to Chinese Patent Application No. 202022477926.3, filed on Oct. 30, 2020, in the China National Intellectual Property Administration, the entire contents of which are incorporated herein by reference.

### FIELD

This application relates to the field of display devices, in particular to a display cable management structure and a display.

### BACKGROUND

There are mainly two types of traditional display cable management structures, one is a toggle clip-shaped structure, and the other is a cord fastener-shaped structure. When the toggle clip-shaped structure is used, a clamping structure needs to be fixed to a bracket of a display, and a cable is clamped through a clamping buckle on the other side of the clamping structure. When the cord fastener-shaped structure is used, a cord needs to be fixed to the bracket, and the cable is fixed by the cord.

### SUMMARY

This application provides the following technical solutions.

In one aspect, this application provides a display cable management structure, including a bracket with a groove, where the groove forms an arrangement space for accommodating a cable, and the groove is provided with at least one stop block for preventing the cable from falling out of the arrangement space; and the at least one stop block is movably installed in the groove in an extending direction of the groove, and the at least one stop block separates an opening of the groove into two cable passing openings for the cable to pass in and out of the arrangement space.

In some embodiments, the opening of the groove extends from a top of the bracket to a back of the bracket.

In some embodiments, the groove is provided with two stop blocks, and the two stop blocks are arranged in the extending direction of the groove.

In some embodiments, the stop blocks are slidably connected with the groove through a keyway, where

an inner wall of the groove is provided with sliding grooves, and the stop blocks are provided with sliding rails corresponding to the sliding grooves; or

an inner wall of the groove is provided with sliding rails, and the stop blocks are provided with sliding grooves corresponding to the sliding rails.

In some embodiments, when the inner wall of the groove is provided with the sliding rails, the sliding rails are in interference fit with the groove.

In some embodiments, when the stop blocks are provided with the sliding rails and the inner wall of the groove is provided with the sliding grooves, for each pair of sliding rail and sliding groove in one-to-one correspondence, a surface of the sliding rail is provided with a raised rib for abutting against an inner surface of the sliding groove.

In some embodiments, the at least one stop block protrudes from the back of the bracket.

In some embodiments, a preparation material of the at least one stop block is silica gel.

In some embodiments, a hardness of the silica gel ranges from 75 degrees to 85 degrees.

In another aspect, this application further provides a display, including any one display cable management structure provided according to the above technical solutions.

### BRIEF DESCRIPTION OF THE DRAWINGS

FIG. 1 is a schematic structural diagram of a display cable management structure provided according to an embodiment of the present application.

FIG. 2 is another schematic structural diagram of a display cable management structure provided according to an embodiment of the present application.

FIG. 3 is a schematic structural diagram of a rod part of a bracket in FIG. 1.

FIG. 4 is a schematic structural diagram of a stop block in FIG. 1.

FIG. 5 is a schematic diagram of an assembly of a structure in FIG. 1.

### DETAILED DESCRIPTION OF THE EMBODIMENTS

In order to make the object, technical solutions and advantages of the present application clearer, this application will be further described in detail below in conjunction with the accompanying drawings. Apparently, the described embodiments are only a part of the embodiments of this application, not all the embodiments. Based on the embodiments in this application, all other embodiments obtained by those of ordinary skill in the art without creative work shall fall within the protection scope of this application.

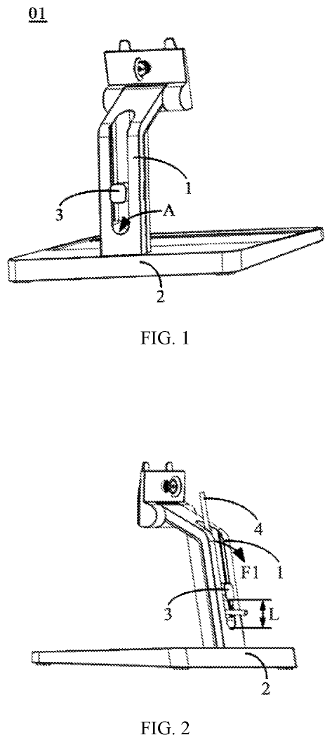

This application provides a display cable management structure 01. The display cable management structure 01 includes a bracket. As shown in FIG. 1 and FIG. 2, the bracket exemplarily includes a rod part 1 and a base 2. The rod part 1 has a groove, the groove forms an arrangement space for accommodating a cable 4, and the groove is provided with a stop block 3 configured to prevent the cable 4 from falling out of the arrangement space. The stop block 3 may be movably installed in the groove in an extending direction of the groove, and the stop block 3 separates an opening of the groove into two cable passing openings for the cable 4 to pass in and out of the arrangement space.

In the above display cable management structure 01, the display cable management structure 01 includes the bracket, the bracket includes the rod part 1 and the base 2, and the rod part 1 has the groove. When the above bracket is applied, the cable 4 may be placed in the arrangement space formed by the groove, and the stop block 3 is adopted to block the cable 4 to prevent the cable 4 from falling out of the arrangement space. Due to the fact that the stop block 3 separates the opening of the groove into the two cable passing openings, and the stop block 3 may move relative to the groove in the extending direction of the groove, sizes of the two cable passing openings may be changed by moving the stop blocks 3.

The display cable management structure 01 provided according to the present application stores the cable 4 in the arrangement space on a back of the bracket, which may enhance aesthetics of the entire cable management structure. At the same time, the display cable management structure 01 provided according to the present application allows the relative sizes of the two cable passing openings to be adjusted by adjusting the position of the stop block 3, so that the tightness of the cable management of the cable management structure and a fixing position of the cable 4 may be adjusted.

Therefore, the above display cable management structure 01 facilitates the adjustment of the cable management tightness and the fixing position of the cable 4 by changing the cable management structure.

It is worth noting that due to the fact that the stop block 3 is matched with an inner wall of the groove on a back of the rod part, there is no need to worry that the cable management structure will cause poor appearance, which makes an overall appearance of a device more aesthetically pleasing.

Based on the above technical solutions, as shown in FIG. 1 and FIG. 2, the opening of the groove extends from a top of the rod part 1 to the back of the bracket.

It should be noted that a distance L between an inner surface A in the groove and the stop blocks 3 affects the tightness of the cable management of the wire management structure. When the cable 4 needs to be fastened, the stop block 3 may be moved towards the surface A; and when the cable 4 needs to be loosened, the stop block 3 may be moved away from the surface A.

Of course, the groove may also be a through groove, that is, the opening of the groove extends from a top to a bottom of the bracket. At this time, an upper surface of the base 2 functions as the inner surface A of the groove.

It should be noted that when a connecting head at an end of the cable 4 is smaller than the sizes of the cable passing openings, the cable 4 may directly enter the arrangement space from the cable passing openings. In some embodiments, connecting heads at ends of the cable 4 have numerous sizes. In order to adapt to the cable 4 connected with connecting heads of various sizes, the stop block 3 is detachably connected to the groove.

In some embodiments, during cable management, the stop block 3 may be firstly removed from the groove, the cable 4 is placed along the groove of the rod part 1, then the stop block 3 is installed back to the groove, and the stop block 3 is adopted to adjust the cable management tightness according to usage requirements.

In some embodiments, in order to avoid that when the cable 4 is too long, part of the cable 4 falls out of the arrangement space in the direction F1 in FIG. 2, the two stop blocks 3 may be used to block the cable 4. In one embodiment, the two stop blocks 3 are arranged in the extending direction of the groove, one stop block 3 is configured to adjust the cable management tightness, and the other stop block 3 is configured to prevent the cable 4 from falling out of the arrangement space in the direction F1 in FIG. 2.

Based on the above technical solutions, in one embodiment, the stop blocks 3 are slidably connected with the groove through a keyway.

In some embodiments, sliding grooves may be formed in the inner wall of the groove, and the stop blocks 3 are provided with sliding rails in one-to-one correspondence with the sliding grooves; or sliding rails may be arranged on the inner wall of the groove, and the stop blocks 3 are provided with sliding grooves in one-to-one correspondence with the sliding rails.

It is worth noting that when the groove is provided with the sliding rails, the sliding rail structure may be formed directly on the inner wall of the groove, or a method of embedding the sliding rails in the inner wall of the groove may be adopted. When the sliding rails are embedded in the inner wall of the groove, the sliding rails and the groove may be fixed by an interference fit.

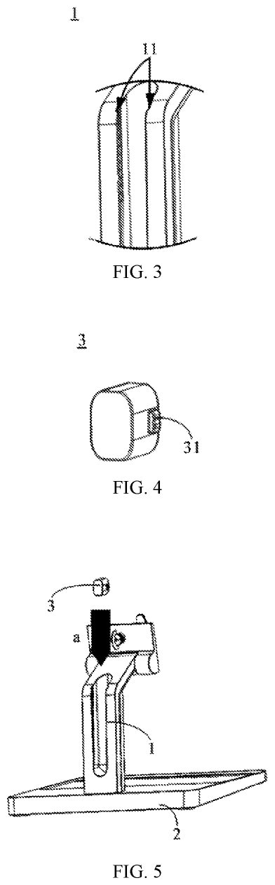

In some embodiments, two opposite sides of the groove are provided with the sliding grooves 11 as shown in FIG. 3, and a side of the stop block 3 corresponding to each of the above two sides is provided with the sliding rail 31 as shown in FIG. 4. It should be noted here that each sliding groove 11 in FIG. 3 extends in an extending direction of the rod part 1. When the stop block 3 is installed relative to the groove, the sliding rails 31 may be embedded in the sliding grooves 11 in one-to-one correspondence with the sliding rails in a direction ‘a’ in FIG. 5.

Due to the fact that each pair of sliding rail 31 and sliding groove 11 in one-to-one correspondence is in frictional fit in the keyway, and a thrust to push the stop block 3 is related to the magnitude of a frictional force, the greater the frictional force between the sliding rails 31 and the sliding grooves 11, the greater the thrust required to slide the stop block 3. In order to enable the stop block 3 to adjust the cable management tightness according to requirements, in some embodiments, surfaces of the sliding rails 31 on each side of the stop block 3 are provided with raised ribs for abutting against inner surfaces of the sliding grooves 11.

It should be noted that by adjusting protruding lengths of the raised ribs, deformation of the stop blocks 3 after being placed in the groove may be changed, thereby adjusting an extrusion force between the sliding rails 31 and the sliding grooves 11 and adjusting the magnitude of the frictional force. In some embodiments, the surfaces of the sliding rails 31 may also be planes.

Based on the above technical solutions, in order to facilitate an operator to move the stop block 3 relative to the sliding grooves 11, as shown in FIG. 2, the surface of the stop block 3 protrudes from the back of the bracket.

In some embodiments, as shown in FIG. 4, the sliding rail 31 may be arranged at a position, close to the bracket, of each side of the stop block 3 to ensure that the surface of the stop block 3 protrudes from the back of the bracket. It should be noted that the above structural design may achieve small size designs of the stop block 3 on the premise that the stop block 3 fits into the keyway of the sliding grooves 11.

Based on the above technical solutions, a preparation material of the stop block 3 may be silica gel. In some embodiments, a hardness of the silica gel ranges from 75 degrees to 85 degrees. In other words, the stop block 3 is a hard silica gel stop block 3.

It should be noted that the hard silica gel stop block 3 may achieve better assembly and sliding effects. Exemplarily, the hardness of the silica gel may be 75 degrees, 80 degrees or 85 degrees.

On the other hand, this application further provides a display, including any one display cable management structure 01 provided according to the above technical solutions.

Apparently, those skilled in the art may make various modifications and variations to this application without departing from the spirit and scope of this application. In this way, if these modifications and variations of this application fall within the scope of the claims of this application and their equivalent technologies, this application is also intended to include these modifications and variations.

What is claimed is:

1. A display cable management structure, comprising:
a bracket with a groove,
wherein the groove forms an arrangement space for accommodating a cable, and
the groove is provided with at least one stop block for preventing the cable from falling out of the arrangement space; and
wherein the at least one stop block is movably installed in the groove in a direction of extension of the groove, and
the at least one stop block separates an opening of the groove into two cable passing openings for the cable to pass in and out of the arrangement space.

2. The display cable management structure of claim 1, wherein the opening of the groove extends from a top of the bracket to a back of the bracket.

3. The display cable management structure of claim 2, wherein the groove is provided with two stop blocks, and the two stop blocks are arranged in the direction of extension of the groove.

4. The display cable management structure of claim 3, wherein the stop blocks are slidably connected with the groove through a keyway, and wherein
an inner wall of the groove is provided with sliding grooves, and the stop blocks are provided with sliding rails corresponding to the sliding grooves; or
an inner wall of the groove is provided with sliding rails, and the stop blocks are provided with sliding grooves corresponding to the sliding rails.

5. The display cable management structure of claim 4, wherein when the inner wall of the groove is provided with the sliding rails, the sliding rails are in interference fit with the groove.

6. The display cable management structure of claim 4, wherein when the stop blocks are provided with the sliding rails and the inner wall of the groove is provided with the sliding grooves, for each pair of sliding rail and sliding groove in one-to-one correspondence, a surface of the sliding rail is provided with a raised rib for abutting against an inner surface of the sliding groove.

7. The display cable management structure of claim 1, wherein the at least one stop block protrudes from a back of the bracket.

8. The display cable management structure of claim 1, wherein a preparation material of the at least one stop block is silica gel.

9. The display cable management structure of claim 8, wherein a hardness of the silica gel ranges from 75 degrees to 85 degrees.

10. A display, comprising a display cable management structure, wherein the display cable management structure comprises a bracket with a groove, and
wherein the groove forms an arrangement space for accommodating a cable, and
the groove is provided with at least one stop block for preventing the cable from falling out of the arrangement space; and
wherein the at least one stop block is movably installed in the groove in a direction of extension of the groove, and
the at least one stop block separates an opening of the groove into two cable passing openings for the cable to pass in and out of the arrangement space.

11. The display of claim 10, wherein the opening of the groove extends from a top of the bracket to a back of the bracket.

12. The display of claim 11, wherein the groove is provided with two stop blocks, and the two stop blocks are arranged in the direction of extension of the groove.

13. The display of claim 12, wherein the stop blocks are slidably connected with the groove through a keyway, and wherein
an inner wall of the groove is provided with sliding grooves, and the stop blocks are provided with sliding rails corresponding to the sliding grooves; or
an inner wall of the groove is provided with sliding rails, and the stop blocks are provided with sliding grooves corresponding to the sliding rails.

14. The display of claim 13, wherein when the inner wall of the groove is provided with the sliding rails, the sliding rails are in interference fit with the groove.

15. The display of claim 13, wherein when the stop blocks are provided with the sliding rails and the inner wall of the groove is provided with the sliding grooves, for each pair of sliding rail and sliding groove in one-to-one correspondence, a surface of the sliding rail is provided with a raised rib for abutting against an inner surface of the sliding groove.

16. The display of claim 10, wherein the at least one stop block protrudes from a back of the bracket.

17. The display of claim 10, wherein a preparation material of the at least one stop block is silica gel.

18. The display of claim 17, wherein a hardness of the silica gel ranges from 75 degrees to 85 degrees.
